(19) United States
(12) Patent Application Publication
(10) Pub. No.: US 2007/0298514 A1
(43) Pub. Date: Dec. 27, 2007

(54) Microlaboratory For Biological Fluids Analysis Using White Light Illumnation

(75) Inventors: Jose Higino Gomes Correia, Braga (PT); Graca Maria Henriques Minas, Graga (PT); Jose Carlos De Almeida Ribeiro, Oliveira De Azemeis (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DO MINHO, Braga (PT)

(21) Appl. No.: 11/631,304

(22) PCT Filed: Jul. 1, 2005
(86) PCT No.: PCT/IB05/52200

§ 371 Date: Jan. 3, 2007

(30) Foreign Application Priority Data
Jul. 5, 2004 (PT) 103159

(51) Int. Cl. G01N 21/00; G01N 21/01

(52) U.S. Cl. 436/164; 422/82.09

(57) ABSTRACT

The present invention relates a laboratorial microsystem for biological fluid analysis, especially the concentration measurement of biomolecules in those fluids, for application in clinical analyses. This device combines in a single microsystem the microchannels, the optical filters, the detectors and the readout electronics, enabling the measurement of the concentration of several biomolecules using white light source as illumination, thus avoiding the use of a wavelength dependent light source (such as a laser, for example). Its operation is based on colorimetric detection by optical absorption. A white light beam is guided through the microchannels containing the samples to analyse. The impinging light is filtered by a narrow passband optical filter at the wavelength defined by the biomolecule being analysed. The intensity of the selected spectral component transmitted through the fluid, proportional to the concentration of the biomolecule in analysis, is measured using an underlying photo-detector, vertically aligned with the optical filter.

### FIELD OF THE INVENTION

The invention relates a laboratorial microsystem for analysing biological fluids (such as urine, blood, saliva, cerebrospinal fluid, etc.), especially the measurement of the concentration of biomolecules in those fluids (such as uric acid, albumin, total protein, etc.).

### BACKGROUND OF THE INVENTION

Automated equipments are commercially available and used in clinical laboratories performing several and simultaneously tests for each biological fluid. Nowadays, those equipments are extremely sophisticate, precisely and accurate. However, they use high reagent and sample volumes making the analysis systems expensive. In addition, to perform these analyses it takes several hours or even days.

For diagnostic reasons patients are often subjected to biochemical analysis of their biological body fluids. Usually the analyses are carried out in clinical laboratories. All this process needs long time and a reliable diagnosis cannot be performed within the consultation time (only after the receiving of the requested analysis results). Besides time delay, mistakes in the logistics, such as lost samples and mislabelling, may further delay diagnosis.

Outside the laboratory environment, reagent strips are commercially available for routine analyses of biological fluids (urine and blood). They can be used, read and interpreted directly by the patients and by the health care personal. Those strips are chemically impregnated with reagent and allow quantifying the concentration values of certain biomolecules in urine, using a visual comparison process codified by colours. The reaction times of the chemical biomolecules in the strips are standardised for each strip class. Actually, these reagent strips work as miniaturised laboratories, however, they are available for a limited set of biomolecules to be analysed (pH, total protein, glucose, bilirubin, nitrite, and haemoglobin) and the colour readout, even with controls, is merely qualitative.

There are several methods for measuring the concentration of biomolecules, such as: fluorescence, electrochemical and optical absorption. The fluorescence detection method has high detection sensitivity. However, the time of the fluorescent light emitted by the molecules is extremely short. Moreover, it is not easy to find a reagent that forms a strongly fluorescence complex. The electrochemical method has also high detection sensitivity, but its application is limited to only some compounds. The optical absorption measurement method can be applied to a wide range of analyses and has the advantage that it is not necessary fluorescent compounds for the detection.

The patents US2003017079A1—‘Absorbance detection system for lab-on-a-chip’ and U.S. Pat. No. 6,048,498—‘Microfluidic devices and systems’—use the optical absorption method for measuring the concentration of biomolecules, but they need a monochromatic light source and also the patent US2003017079A1 uses optical fibres to guide the light. The present invention does not need optical fibres to guide the light and does not need a specific monochromatic light source, once it only needs white light source and the required wavelength is selected by optical filters.

The patent WO0170400—‘Multiblock micro-arrays or macro-arrays with lab-on-a-chip’—needs mixers to mix the reagents. The fabrication of those mixers, in that patent, is very complex due to their vertical multi-structures. The present invention does not need micromixers, once the mixing is performed by diffusion, which highly simplifies the device fabrication.

The patent US2003052281—‘Apparatus to collect, classify, concentrate, and characterize gas-borne particles’—needs UV light source. The UV detectors are very difficult to fabricate in silicon. The present invention uses white light source, using optical filters for the filtering and detectors for the visible spectral range that are simple to fabricate in silicon.

The patents U.S. Pat. No. 6,129,896—‘Biosensor chip and manufacturing method’—and U.S. Pat. No. 5,755,942—‘Partitioned microelectronic device array’—need to have recourse to optical fibres to guide the light, which requires a monochromatic light source. The present invention does not need optical fibres to guide the light and does not need a specific monochromatic light source.

The patent U.S. Pat. No. 6,100,973—‘Methods and apparatus for performing microanalytical techniques using photolitographically fabricated substrates having narrow band optical emission capability’—uses the fluorescence detection method, which limits its application to only some compounds. The present invention uses the optical absorption detection method, which can be applied to a wide range of compounds and consequently to a wide range of analyses and does not need fluorescent compounds for the detection.

None of these documents advances the object of the requested patent that now is intended to protect.

### SUMMARY OF THE INVENTION

The objective of the invention is to quantify the concentration of biomolecules in human fluids, with instantaneous results and at any location, using a regular white light source for illumination, such as a commercially available fluorescent light, with low cost and without the use of complex and expensive analyses systems as the spectrophotometer.

The present invention is a portable microlaboratorial equipment for clinical diagnosis. It combines in a single microsystem the microchannels, the optical filters, the detectors and the readout electronics. This device allows quantifying the concentration of biomolecules without external components. The equipment will allow performing clinical analyses in doctor's office during the consultation time, on-line (Point Of Care), in the clinical analyses laboratories and at patient's home, allowing the exact determination of the concentration of biomolecules in biological fluids.

It measures the concentration value using white light source as illumination, with the help of the optical filters. This characteristic shows an important advantage, because it avoids the need of a specific monochromatic light source, like a laser, it does not need optical fibres for guiding and directing the light for polarising and, once optical absorption detection method is used, fluorescent biomolecules are not needed.

The simplicity of its utilisation allows predicting that the own patients will be qualified to use the equipment and perform their own analyses.

Its small dimensions, low-power consumption and portability, presents instantaneous results with the same viability an precision of the biological fluids analyses systems that are available nowadays in clinical laboratories, and using low quantities of reagents and samples.

### BRIEF DESCRIPTION OF THE DRAWINGS

In attach there is a sheet with the drawings, without restrictive character, in which is described, schematically, the laboratorial microsystem for biological fluids analysis.

FIG. 1 presents the microlaboratory in its several parts, in which (1) presents the polystyrene die that contains the holes for the injection and the removing of the fluids, (2) presents the polystyrene die with the microchannels, (3) presents the optical filters group placed under the detection chamber (enlarged figure to point out the 16 optical filters), and (4) presents an integrated circuit with the silicon die that contains the photodetectors and readout electronics.

FIG. 2 presents the reader in which the microlaboratory (5) is inserted. The reader also includes a display (6), which allows visualising the quantitative result of the analysis.

### DETAILED DESCRIPTION OF THE INVENTION

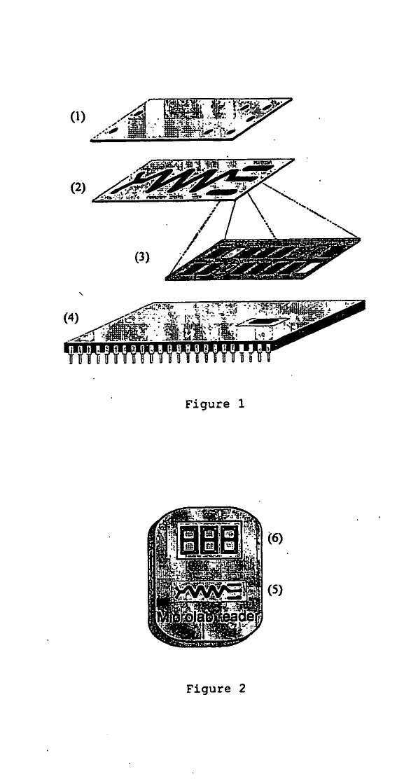

The Microlab measures the concentration value of the biomolecules in biological fluids with instantaneous results and at any location, combining in a single microsystem the microchannels, the optical filters, the detectors and the readout electronics, and is schematically described in the drawing of FIG. 1.

The module for carrying the fluids is micromachined in polystyrene (using micromilling techniques for fabricating the microchannels, with SiO₂ passivation and annealing for eliminating the roughness and the residual stress) and is composed by two dies (1) and (2) each one with 1 mm thick, 25 mm long and 10 mm wide. The first die (1) has the holes for the injection and removing of the fluids (inlets and outlets) and the second (2) includes the microchannels.

The microlaboratory comprises basically three microchannels: one to obtain the baseline reference and to calibrate the light source, other allows the analysis of the mixed solution, it has two inlets and one outlet for allowing the automatic mixing between the fluid and the reagent, and the third microchannel is needed to calibrate the biomolecule concentration that will be measured (with a well-known concentration calibrator). The shape of the microchannels is rectangular due to the light reflexion, once the measurement method is by optical absorption.

The optical filters module (3) is placed under the module for carrying the fluids and is composed of a 0.5 mm thick die. It is on this die where the dielectric thin films will be deposited, with a multilayer structure, to form narrow pass-band optical filters. The thin films can be deposited by PVD (Physical Vapor Deposition), such as sputtering, electron beam, etc.

The optical filters select the wavelength, within the visible spectrum, suitable to the biomolecules in analysis. The use of the optical filters allows that the microlaboratory performs measurements using a regular white light source for illumination (with all wavelengths, such as a commercially available fluorescent light). The number of the optical filters depends on the number of the biomolecules to be analysed. It is necessary one filter for each biomolecule.

The detection system module (4) is placed under the other two and is fabricated by a standard CMOS microelectronics process. It includes an array of photodetectors to measure the intensity of the light beam transmitted through the mixture. This impinging light, with several spectral components, is filtered by the optical filters, to a narrow spectral band with only some spectral components. The photodetectors number depends on the optical filter number. The photodetectors array is placed under the optical filters array and vertically aligned with them. An analog to digital converter was integrated with the photodetectors (in the same fabrication process) to convert the analog signal into a digital signal.

After packaging the detection system, fabricated in silicon, it is placed on its top the die with the optical filters. The device is assembled with a reader containing a display connected to the integrated circuit that contains the detection system. The display is used to show the quantitative results. It avoids the connection to a computer, which gives portability to the microlaboratory. The microchannels module is placed on the reader in its right place, with the measuring area over the optical filters. This module is disposable, avoiding the costs associated with the cleanning of the reagents. The remaining modules and the reader are used in several analyses.

The number of biomolecules that can be determined with this equipment depends on the number of optical filters that are placed in the array. In a laboratorial example, it has been possible to determine the concentration of 16 different biomolecules in biological fluids, using 16 optical filters (3). The biomolecules analysed are indicated in table 1:

TABLE 1
Analysed biomolecules. S (serum), U (urine), B (blood), P (plasma)
and CFS (cerebrospinal fluid). The 4^{th} column indicates the filter
that corresponds to the biomolecule in analysis.

| Biological | Biological | Absorption spectra | Filter position |
|---|---|---|---|
| biomolecules | Fluid | maximum peak (nm) | in the array |
| 17 - Ketosteroids | U | 478 | 1 |
| Aldolase | S | 484 | 2 |
| Uric Acid | U, CSF | 497 | 3 |
| Cholesterol | S | 500 | 4 |
| Glucose | S | 504 | 5 |
| Glutamic oxalacetic | S, P, CSF | 508 | 6 |
| Urea nitrogen | U, S, P | 514 | 7 |
| Magnesium | S | 518 | 8 |
| Creatinine | U, S, P | 523 | 9 |
| Bile acids | S | 528 | 10 |
| Blood urea nitrogen | S, P | 535 | 11 |
| Salicylate | S | 540 | 12 |
| Hemoglobin | P | 543 | 13 |
| β-Glucuronidase | S, U | 548 | 14 |
| Bilirubin | S | 558 | 15 |
| Leucine | U | 567 | 16 |
| aminopeptidase | | | |

1. An apparatus for optical absorption analysis of biological fluid samples characterized in that it uses any external white light illumination source and comprises in a multi-chip-module:
(i) a microfluidic mixing system for automatic mixing two or more fluids, comprising a transparent die with the holes for injection and removal of the fluids (1) and a die with the microchannels, which are vertically aligned with the holes, being the holes placed in the beginning and in the ending of each microchannel, and 3 detection chambers (2), or multiples thereof, wherein one chamber contains the blank reagent, other chamber contains the reagent plus the sample to analyse and the other chamber contains a well-known concentration standard of the biomolecule to be analysed;
(ii) a die comprising arrays of highly selective optical filters (3), located vertically under the detection chambers of the microfluidic system, the optical filter arrays having fixed thicknesses;
(iii) a die with photodetectors and readout electronics integrated in the same fabrication process (4), placed under the filter arrays die;
wherein the apparatus is free from any previous calibration, being self calibrated during the effected optical absorption measurements, which simultaneously analyse the light intensities transmitted through the 3 detection chambers.

2. The apparatus of claim 1, wherein the die comprising the microchannels (2) is a transparent material such as glass, quartz and polymeric materials, being a preferable embodiment the die made of a biocompatible photoresist, such as the octafuntional epoxidized novalac, providing a low sidewall roughness and deep rectangular vertical profile of the microchannels and also providing a disposable die.

3. The apparatus of claim 1, wherein the straight microchannels of the detection chambers have a length of 8 times and a width of 2 times of the length and width of one of the optical filters in the arrays and a deep thickness between 0.5 nun and 1 mm, providing high sensitivity optical absorption measurements.

4. The apparatus of claim 1, wherein the number of arrays is the same as the number of the detection chambers.

5. The apparatus of claim 1, wherein each array of highly selective optical filters includes from about 1 to about 32 optical filters and each one is sensitive to a single highly selective spectral band, allowing the simultaneous analysis of more than one biological fluid samples with the same apparatus.

6. The apparatus of claim 1, wherein all the optical filters have the same length and width from about 50 μm to about 1 mm and each optical filter is composed by a stack of several dielectric thin-film layers with only 2 different dielectric materials in the stack, such as TiO₂, and SiO₂, and each optical filter stack having a fixed thickness.

7. The apparatus of claim 1, wherein the spectral band of each optical filter is due to the different thicknesses of one or two dielectric layers, the same layers for all optical filters arrays, obtained during fabrication and keeping the other dielectric layers with the same thicknesses in all optical filters arrays.

8. The apparatus of claim 1, wherein it is placed in a reader (5) with a display (6) for visualizing the results and with a keyboard for entering data, providing portability and the apparatus is free from any physical connection to a computer.

9. The apparatus of claim 8, wherein the reader, the die with the detection and readout electronics (4) and the die with the arrays of highly selective optical filters (3) are the same for all analysis and only the microfluidic mixing system die (1) and (2) is disposable for each analysis.

10. Use of the apparatus according to claim 1, characterized in that a non-calibrated external polychromatic light illumination source can be used, such as a lamp connected to the power supply, being the reliability of the measurements assured by the fact that said apparatus compensates the fluctuations associated to the use of polychroinatic light sources, detecting simultaneously the optical absorption of the fluid samples within the 3 detection chambers.
